(19) United States
(12) Patent Application Publication
(10) Pub. No.: US 2026/0210841 A1
(43) Pub. Date: Jul. 23, 2026

(54) METHOD AND SYSTEM FOR PROBING CHIRALITY PARAMETER BASED ON PHOTONIC SPIN HALL SHIFT

(71) Applicants: SUZHOU CITY UNIVERSITY, Wuzhong (CN); SOOCHOW UNIVERSITY, Wujiang (CN)

(72) Inventors: Dongliang GAO, Suzhou (CN); Hao ZHANG, Suzhou (CN); Khan AIZAZ, Suzhou (CN); Lei GAO, Suzhou (CN); Yadong XU, Suzhou (CN)

(21) Appl. No.: 19/295,632

(22) Filed: Aug. 10, 2025

Related U.S. Application Data
(63) Continuation of application No. PCT/CN2025/100852, filed on Jun. 13, 2025.

(30) Foreign Application Priority Data
Jan. 20, 2025 (CN) 202510085641.X
Apr. 2, 2025 (CN) 202510408513.4

(51) Int. Cl. G01N 21/21

(52) U.S. Cl. CPC G01N 21/21; G01N 2021/216

(57) ABSTRACT

The invention provides a method and system for probing a chirality parameter based on a photonic spin Hall shift. The method includes: acquiring a permittivity, a permeability, and a radius of a chiral nanoparticle to be probed; determining photonic spin Hall shifts of chiral nanoparticles with different chirality parameters under dual-symmetric conditions based on the permittivity, the permeability, and the particle radius, and obtaining a correspondence mapping between the photonic spin Hall shifts and the different chirality parameters; illuminating the chiral nanoparticle to be probed with circularly polarized light to induce Spin Hall Effect of Light, and then adjusting the incident light wavelength until dual symmetry is satisfied to obtain an optimalphotonic spin Hall shift; and determining a chirality parameter of the chiral nanoparticle to be probed based on the optimal photonic spin Hall shift and the correspondence mapping.

This application is a Continuation Application of PCT/CN2025/100852, filed on Jun. 13, 2025, which claims priority to Chinese Patent Application Nos. CN 202510085641.X, filed on Jan. 20, 2025, and CN 202510408513.4, filed on Apr. 2, 2025, all of which are incorporated by reference for all purposes as if fully set forth herein.

### FIELD OF THE INVENTION

The present invention relates to the field of nanophotonics technology, and in particular, to a method and system for probing a chirality parameter based on a photonic spin Hall shift.

### DESCRIPTION OF THE RELATED ART

Chirality is a geometric property where an object is considered to exhibit a chiral structure if it cannot be superimposed onto its mirror image. This characteristic not only exists in geometric shapes but also can manifest in knotted or twisted fields such as left- and right-handed circularly polarized light or fluid vortices. While chiral electromagnetic fields have long been widely used for characterizing chiral substances, their applications have recently expanded to encompass enantioselective biosensing, enantiomer sorting, asymmetric catalysis, nonlinear spectroscopic imaging, among other fields.

When nanostructures possess chirality, they can exhibit pronounced optical activity and can excite highly twisted chiral near-fields. To investigate the characteristics of these near-fields, circular dichroism (CD) spectroscopy is commonly employed. Due to the polarization-dependent interactions of chiral structures with light, optical analysis techniques are particularly suitable for probing and characterizing chirality. Chiral objects are optically active, meaning that their enantiomers respond differently to distinct polarized light states. One manifestation of such optical activity is dichroism, where the absorption of light by chiral objects is polarization-dependent.

As shown in FIG. 1, natural light is first polarized through a polarizer to form linearly polarized light, and then converted by a photo-elastic modulator to form circularly polarized light. When chiral molecules interact with left- and right-handed circularly polarized light, CD spectroscopy detects differential absorption. Circularly polarized light is chiral, as it propagates via two linear components with a phase difference of ±π/2, generating a three-dimensional helical motion. Chiral molecules preferentially absorb light matching their handedness. While the absorption component dominates the extinction coefficient of small molecules, for large nanoparticles and macromolecules, the scattering component in their extinction coefficient can significantly enhance the measured CD signal.

However, when CD spectroscopy employs the difference in extinction between left- and right-handed circularly polarized light, cancellation effects may arise. Such effects may prevent the peak intensities and sign reversals in CD spectra from accurately reflecting the intrinsic characteristics of near-field chiral information. Specifically, this manifests as insufficient measurement sensitivity and compromised accuracy, thereby limiting the practical utility of CD spectroscopy to some extent.

### SUMMARY OF THE INVENTION

For this, a technical problem to be resolved by the present invention is to overcome the problem in the prior art that when CD spectroscopy employs the difference in extinction between left- and right-handed circularly polarized light, cancellation effects arise and prevent the peak intensities and sign reversals in CD spectra from accurately reflecting the intrinsic characteristics of near-field chiral information, thereby affecting the sensitivity and accuracy of measurements.

According to a first aspect, to resolve the foregoing technical problems, the present invention provides a method for probing a chirality parameter based on a photonic spin Hall shift, including, but not limited to, the following steps:
S1, acquiring a permittivity, a permeability, and a particle radius of a chiral nanoparticle to be probed;
S2, determining photonic spin Hall shifts of chiral nanoparticles with different chirality parameters under dual-symmetric conditions based on the permittivity, the permeability, and the particle radius, and obtaining a correspondence mapping between the photonic spin Hall shifts and the different chirality parameters;
S3, illuminating the chiral nanoparticle to be probed with circularly polarized light to induce Spin Hall Effect of Light, and when the Spin Hall Effect of Light is induced, adjusting an incident light wavelength until dual symmetry is satisfied to obtain an optimal photonic spin Hall shift; and
S4, determining a chirality parameter of the chiral nanoparticle to be probed based on the optimal photonic spin Hall shift and the correspondence mapping.

In an embodiment of the present invention, the step of determining photonic spin Hall shifts of chiral nanoparticles with different chirality parameters under dual-symmetric conditions based on the permittivity, the permeability, and the particle radius in S2 is:
obtaining a constitutive relation of the chiral nanoparticle to be probed based on the permittivity, the permeability, and the particle radius;
constructing an incident field model and a scattering field model, and obtaining a photonic spin Hall shift expression based on the incident field model, the scattering field model, and the constitutive relation; and
determining the photonic spin Hall shifts of the chiral nanoparticles with the different chirality parameters based on the photonic spin Hall shift expression under the dual-symmetric conditions.

In an embodiment of the present invention, the step of obtaining a correspondence mapping between the photonic spin Hall shifts and the different chirality parameters in S2 is:
constructing an interior field model of the chiral nanoparticle for obtaining a first scattering coefficient and a second scattering coefficient;
calculating a first scattering matrix amplitude and a second scattering matrix amplitude based on the first scattering coefficient and the second scattering coefficient; and
obtaining the correspondence mapping between the photonic spin Hall shifts and the different chirality parameters based on the first scattering matrix amplitude and the second scattering matrix amplitude.

In an embodiment of the present invention, the step of constructing an interior field model of the chiral nanoparticle for obtaining a first scattering coefficient and a second scattering coefficient is:
decomposing any optical field entering a chiral medium into a left-handed circularly polarized field component and a right-handed circularly polarized field component;
constructing a first expansion coefficient and a first wavenumber of the left-handed circularly polarized field component, constructing a second expansion coefficient and a second wavenumber of the right-handed circularly polarized field component, and constructing the interior field model of the chiral nanoparticle based on the first expansion coefficient, the first wavenumber, the second expansion coefficient, and the second wavenumber; and
acquiring the incident field model and the scattering field model, and calculating the first scattering coefficient and the second scattering coefficient based on the incident field model, the scattering field model, and the interior field model.

In an embodiment of the present invention, the photonic spin Hall shift expression is:

$${Δ}_{S H} = \frac{1}{k} \frac{\begin{matrix}\sqrt{2} sin θ \cdot Re ( {S}_{1}^{*} \cdot ( {\sum }_{n = 1}^{∞} ( {( - i )}^{n + 1} n ( n + 1 ) {B}_{1 n}^{s} \frac{{P}_{n}^{1}}{sin θ} ) ) + \\ {S}_{2} \cdot {\sum }_{n = 1}^{∞} ( {( i )}^{n + l} n ( n + 1 ) {( {A}_{1 n}^{s} \frac{{P}_{n}^{1}}{sin θ} )}^{*} ) )\end{matrix}}{{\vert {S}_{2} \vert}^{2} + {\vert {S}_{1} \vert}^{2}} ,$$

where Δ_{SH} is the photonic spin Hall shift, k is the wavenumber in an ambient medium, θ is the second component of a coordinate vector in a spherical coordinate system, Re(⋅) represents taking the real part of a complex number, n is the first summation index, I is the imaginary unit,

$${A}_{1 n}^{s}$$

is the first scattering coefficient when a second summation index is 1,

$${B}_{1 n}^{s}$$

in is the second scattering coefficient when the second summation index is 1,

$${P}_{n}^{1}$$

is the associated Legendre polynomial when the second summation index is 1, S₁ is the first scattering matrix amplitude, S₂ is the second scattering matrix amplitude, and (⋅)* represents complex conjugation of a complex number.

In an embodiment of the present invention, the process of determining photonic spin Hall shifts of chiral nanoparticles with different chirality parameters under dual-symmetric conditions based on the permittivity, the permeability, and the particle radius in S2 further includes constructing a transfer function, and minimizing the transfer function by adjusting the incident light wavelength to obtain the dual-symmetric conditions.

In an embodiment of the present invention, an expression of the transfer function is:

$$𝒯 = \frac{{\sum }_{n = 1}^{∞} \frac{{n}^{2} {( n + 1 )}^{2}}{2 n + 1} {\vert {A}_{1 n}^{s} - {B}_{1 n}^{s} \vert}^{2}}{{\sum }_{n = 1}^{∞} \frac{{n}^{2} {( n + 1 )}^{2}}{2 n + 1} {\vert {A}_{1 n}^{s} + {B}_{1 n}^{s} \vert}^{2}}$$

where τ is the transfer function, n is the first summation index,

$${A}_{1 n}^{s}$$

is the first scattering coefficient when a second summation index is 1, and

$${B}_{1 n}^{s}$$

is the second scattering coefficient when the second summation index is 1.

In an embodiment of the present invention, after the adjusting an incident light wavelength until dual symmetry is satisfied in S3, the method further includes measuring a photonic spin Hall shift of the chiral nanoparticle to be probed, and steps of measuring the photonic spin Hall shift are:
passing a beam through a first polarizer to reach a preselected state;
transmitting the beam through a high-refractive-index-contrast material based on the preselected state to induce a weak coupling interaction to generate a transverse displacement; and
extracting scattering field signatures associated with the transverse displacement through a second polarizer, where polarization axes of the first polarizer and the second polarizer are mutually perpendicular.

According to a second aspect, to resolve the foregoing technical problems, the present invention provides a system for probing a chirality parameter based on a photonic spin Hall shift, including:
an acquisition module, configured to acquire a permittivity, a permeability, and a particle radius of a chiral nanoparticle to be probed;
a correspondence mapping acquisition module, configured to: determine photonic spin Hall shifts of chiral nanoparticles with different chirality parameters under dual-symmetric conditions based on the permittivity, the permeability, and the particle radius, and obtain a correspondence mapping between the photonic spin Hall shifts and the different chirality parameters;
an adjustment module, configured to: Illuminate the chiral nanoparticle to be probed with circularly polarized light to induce a Spin Hall Effect of Light, and when the Spin Hall Effect of Light is induced, adjust an incident light wavelength until dual symmetry is satisfied to obtain an optimal photonic spin Hall shift; and
a determination module, configured to determine a chirality parameter of the chiral nanoparticle to be probed based on the optimal photonic spin Hall shift and the correspondence mapping.

According to a third aspect, to resolve the foregoing technical problems, the present invention provides a chiral molecule detection apparatus, including the foregoing system for probing a chirality parameter based on a photonic spin Hall shift.

Compared with the prior art, the foregoing technical solution of the present invention has the following beneficial effects:
(1) The method and system for probing a chirality parameter based on a photonic spin Hall shift of the present invention establish a detailed correspondence mapping between photonic spin Hall shifts and chirality parameters. This mapping simplifies a complex procedure of calculation and analysis, and provides an innovative and efficient method for the efficient recognition of chirality parameters. Dual-symmetric conditions are obtained by adjusting an incident light wavelength, so that the present invention can enhance the magnitude of a photonic spin Hall shift, thereby greatly enhancing the sensitivity and accuracy of measurements. This optimization approach ensures measurements under optimal experimental conditions, thereby effectively mitigating an error.
(2) The present invention uses single circularly polarized light to illuminate a chiral nanoparticle to be probed, thereby effectively avoiding the occurrence of cancellation effects. The effect of a photonic spin Hall shift is maximized by further optimizing the incident light wavelength, thereby enhancing the signal contrast ratio. This not only enhances the characterization capability for near-field chiral information, but also enables more accurate and comprehensive capture and analysis of near-field chiral signatures.

### BRIEF DESCRIPTION OF THE DRAWINGS

To make the content of the present invention clearer and more comprehensible, the present invention is further described in detail below according to specific embodiments of the present invention and the accompanying draws. Where:

FIG. 1 is a schematic diagram of conventional spectroscopy for chirality probing;

FIG. 2 is a flowchart of a method for probing a chirality parameter based on a photonic spin Hall shift according to a preferred embodiment of the present invention;

FIG. 3 is a schematic diagram of a model of a spin Hall shift induced in a chiral nanoparticle by the illumination of circularly polarized light according to a preferred embodiment of the present invention;

FIG. 4 is a distribution plot of peaks of photonic spin Hall shifts and the logarithm of a transfer function for chiral nanoparticles according to a preferred embodiment of the present invention; and

FIG. 5 is a plot of streamlines of near-field orbital momentum density and corresponding intensity distribution of orbital momentum density for chiral nanoparticles under different chirality parameters according to a preferred embodiment of the present invention.

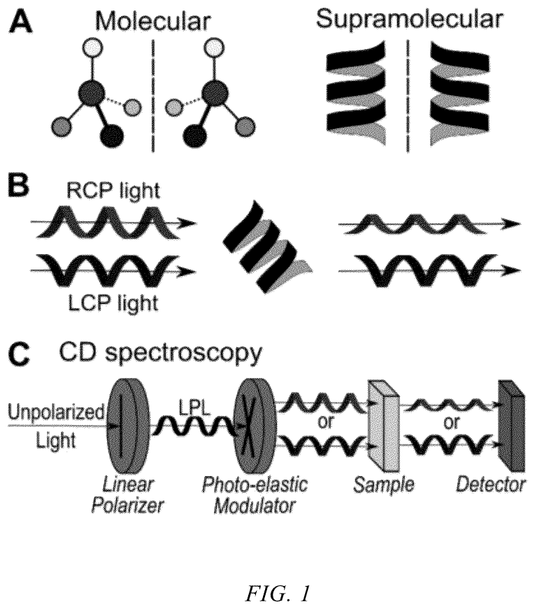

### DETAILED DESCRIPTION OF THE PREFERRED EMBODIMENTS

The present invention is further described below with reference to the accompanying drawings and specific embodiments, to enable a person skilled in the art to better understand and implement the present invention. However, the embodiments are not used to limit the present invention.

### Embodiment 1

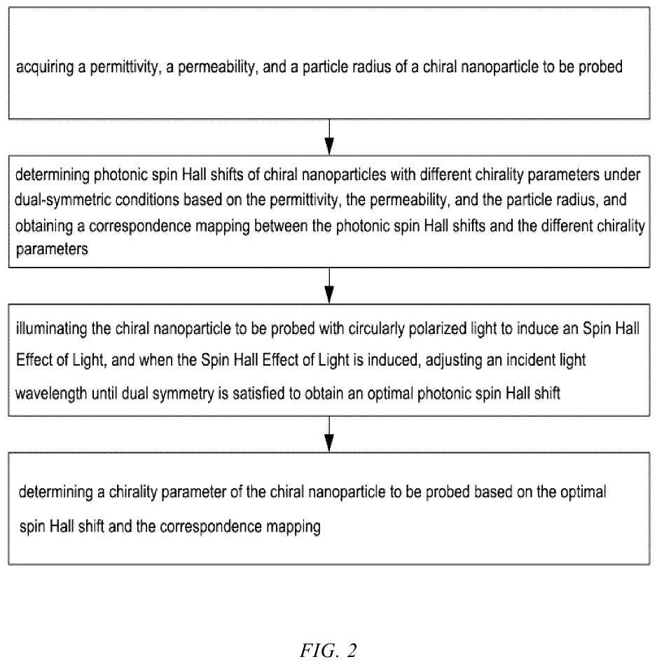

Referring to FIG. 2, embodiments of the present invention provide a method for probing a chirality parameter based on a photonic spin Hall shift, including, but not limited to, the following steps.
S1. Acquire a permittivity, a permeability, and a particle radius of a chiral nanoparticle to be probed.
S2. Determine photonic spin Hall shifts of chiral nanoparticles with different chirality parameters under dual-symmetric conditions based on the permittivity, the permeability, and the particle radius, and obtain a correspondence mapping between the photonic spin Hall shifts and the different chirality parameters.
S3. Illuminate the chiral nanoparticle to be probed with circularly polarized light to induce a Spin Hall Effect of Light, and when the Spin Hall Effect of Light is induced, adjust an incident light wavelength until dual symmetry is satisfied to obtain an optimal photonic spin Hall shift.
S4. Determine a chirality parameter of the chiral nanoparticle to be probed based on the optimal photonic spin Hall shift and the correspondence mapping.

The embodiments of the present invention provide a method for probing a chirality parameter based on a photonic spin Hall shift. Dual-symmetric conditions are satisfied by adjusting an incident light wavelength, so that the effect of a photonic spin Hall shift can be significantly enhanced, thereby enhancing the sensitivity and accuracy of measurements. This optimization steps ensure measurements under optimal conditions, thereby reducing errors. A correspondence mapping between photonic spin Hall shifts and chirality parameters is established, so that chirality parameters can be inversely derived from experimental measurement results rapidly and accurately. This mapping provides an efficient method for the rapid recognition of chirality parameters, thereby reducing a complex process of calculation and analysis. Single circularly polarized light is used to illuminate a chiral nanoparticle to be probed, thereby avoiding the occurrence of cancellation effects. The effect of a photonic spin Hall shift can be maximized by optimizing the Incident light wavelength, thereby enhancing the signal contrast ratio. The characterization capability for near-field chiral information is enhanced, and more accurate and comprehensive capture and analysis of near-field chiral signatures are enabled.

Specifically, in step S1, the related parameters of a particle and the related parameters of incident light are determined. The related parameters of the particle include a permittivity, a permeability, and a particle radius. The related parameters of the incident light include an incident light wavelength. The particle radius may be acquired by using a nanoparticle size analyzer. The measurable range of the nanoparticle size analyzer is 0.3 nanometers to 10 micrometers. The permittivity and the permeability may be acquired by using an impedance analyzer. Through the use of the extremely high sensitivity manifested by a photonic spin Hall shift on the permittivity, the permeability, and the particle radius of a chiral nanoparticle, this embodiment manifests a significantly high sensitivity advantage in terms of chirality probing.

Specifically, in step S2, the photonic spin Hall shifts of the chiral nanoparticles with the different chirality parameters are determined under the dual-symmetric conditions based on the permittivity, the permeability, and the particle radius, to determine the correspondence mapping between the photonic spin Hall shifts and the different chirality parameters.

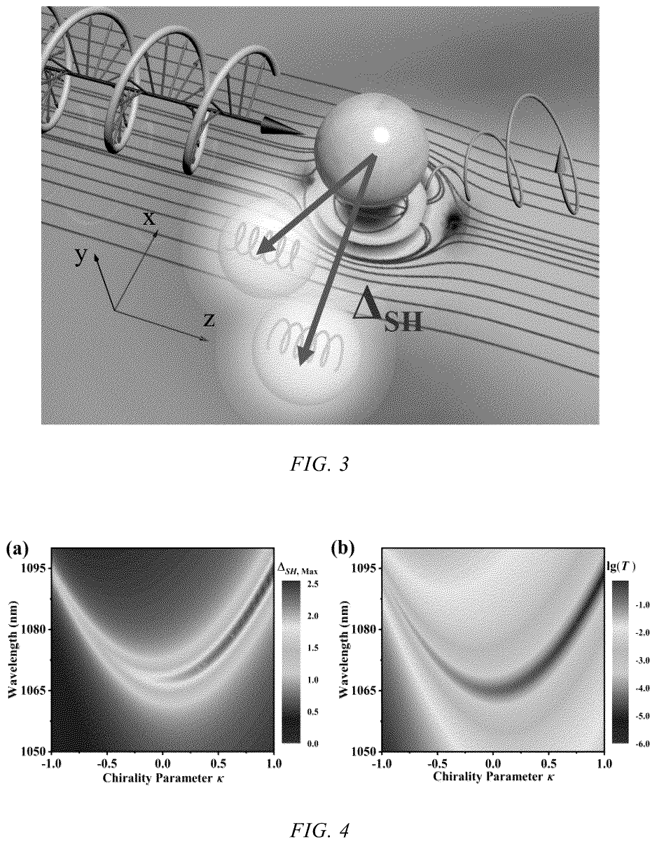

Further, a constitutive relation of the chiral nanoparticle to be probed is obtained based on the permittivity, the permeability, and the particle radius. As shown in FIG. 3, in a spin Hall shift induced in a chiral nanoparticle by the illumination of circularly polarized light, a mathematical expression of the incident right-handed circularly polarized light is:

$$E = ( {E}_{0} / \sqrt{2} ) ( {\hat{e}}_{x} + i {\hat{e}}_{y} ) {e}^{ikz} {e}^{- i ω t} ,$$

where E₀ is the amplitude of an incident wave; êₓ is the unit vector in the direction of the first component x of a coordinate vector in a Cartesian coordinate system; ê_{y} is the unit vector in the direction of the second component y of the coordinate vector in the Cartesian coordinate system; I is the imaginary unit; k is the wavenumber in an ambient medium; co is the angular frequency of the incident wave; z is the unit vector in the direction of the third component z of the coordinate vector in the Cartesian coordinate system; and t is time.

Generally, for substances with a constitutive relation of D=ϵ_{c}E, B=μ_{c}H, such substances generally are not optically active. An optically active chiral medium has a number of constitutive relations, most of which, however, have been proven equivalent to each other. The embodiments of the present invention use a Condon-Rosenfeld constitutive relation, a mathematical expression of which is:

$$D = {ϵ}_{c} E + i κ \sqrt{{ϵ}_{0} {μ}_{0}} H , B = {μ}_{c} H - i κ \sqrt{{ϵ}_{0} {μ}_{0}} E ,$$

where D is the electric displacement vector of the chiral nanoparticle; B is the magnetic induction density of the chiral nanoparticle; ϵ_{c} is the permittivity of the chiral nanoparticle; κ is the chirality parameter (generally ranging from −1 to 1) of the chiral nanoparticle; Σ₀ is the permittivity of vacuum; μ₀ is the permeability of vacuum; H is the magnetic field strength; E is the electric field strength; and μ_{c} is the permeability of the chiral nanoparticle.

Further, an incident field model and a scattering field model are constructed, and a photonic spin Hall shift expression is obtained based on the incident field model, the scattering field model, and the constitutive relation. Specifically, the incident field model and the scattering field model of the chiral nanoparticle are constructed first. The scattering field model is a key physical quantity configured to calculate a photonic spin Hall shift. The incident field model and the scattering field model of the chiral nanoparticle are derived based on Mie scattering theory, with the explicit expressions given as:

$${E}^{ip} = {E}_{0} {\sum }_{n = 1}^{∞} {\sum }_{m = - n}^{n} [ {a}_{mn}^{ip} {M}_{mn}^{( 1 )} ( r , k ) + {b}_{mn}^{ip} {N}_{mn}^{( 1 )} ( r , k ) ] ,$$

$${H}^{ip} = \frac{{kE}_{0}}{i ω μ} {\sum }_{n = 1}^{∞} {\sum }_{m = - n}^{n} [ {a}_{mn}^{ip} {N}_{mn}^{( 1 )} ( r , k ) + {b}_{mn}^{ip} {M}_{mn}^{( 1 )} ( r , k ) ] ,$$

$${E}^{s} = {E}_{0} {\sum }_{n = 1}^{∞} {\sum }_{m = - n}^{n} [ {A}_{mn}^{s} {M}_{mn}^{( 3 )} ( r , k ) + {B}_{mn}^{s} {N}_{mn}^{( 3 )} ( r , k ) ] , and$$

$${H}^{s} = \frac{{kE}_{0}}{i ω μ} {\sum }_{n = 1}^{∞} {\sum }_{m = - n}^{n} [ {A}_{mn}^{s} {N}_{mn}^{( 3 )} ( r , k ) + {B}_{mn}^{s} {M}_{mn}^{( 3 )} ( r , k ) ] ,$$

where E^{ip} is the electric field component of the incident wave; H^{ip} is the magnetic field component of the incident wave; n is the first summation index; m is the second summation index; and in this embodiment, the values of both n and m may be assigned according to an actual requirement. Both

$${M}_{mn}^{( 1 )} ( \cdot ) and {N}_{mn}^{( 1 )} ( \cdot )$$

are the vector spherical harmonic wave functions of the first kind; in this embodiment, a coordinate vector in a spherical coordinate is represented by three components (r, θ, φ); r is the second component of the coordinate vector in the spherical coordinate system; E^{s} represents the scattering field of an electric field;

$${A}_{mn}^{s}$$

is the first scattering coefficient;

$${B}_{mn}^{s}$$

is the second scattering coefficient; both

$${M}_{m n}^{( 3 )} ( \cdot ) and {N}_{m n}^{( 3 )} ( \cdot )$$

are vector spherical harmonic wave functions of the third kind; H^{s} represents the scattering field of a magnetic field; p represents the polarization state of the incident wave; and both

$${a}_{mn}^{ip} and {b}_{mn}^{ip}$$

are the expansion coefficients of the incident wave.

Further, for the value of the expansion coefficients of the incident wave, for example, when the right-handed circularly polarized light is incident:

$${a}_{mn}^{iR} = {b}_{mn}^{iR} = \frac{\sqrt{2}}{2} {i}^{n + 1} \frac{2 n + 1}{n ( n + 1 )} {δ}_{m , 1} .$$

$${A}_{mn}^{iR}$$

is the first expansion coefficient of the right-handed circularly polarized light,

$${b}_{mn}^{iR}$$

is the second expansion coefficient of the right-handed circularly polarized light, and δ_{m,1} is the Kronecker symbol.

Further, an interior field model of the chiral nanoparticle is constructed for calculating the first scattering coefficient and the second scattering coefficient. Inside the chiral nanoparticle, any optical field entering the chiral medium may be decomposed into a left-handed field component and a right-handed field component that are differently circularly polarized (i.e., a left-handed circularly polarized field component and a right-handed circularly polarized field component). The two components possess different amplitudes and phases and different wavenumbers. The amplitudes and phases are described by expansion coefficients Aₘₙ(i.e., the first expansion coefficient of the left-handed circularly polarized field component) and Bₘₙ (i.e., the second expansion coefficient of right-handed circularly polarized field component) of an interior field, and the wavenumbers are affected by the chirality of a medium. The wavenumbers of the left- and right-handed components are respectively: the wavenumber (i.e., a first wavenumber) of the left-handed circularly polarized light is k₁=ω(\sqrt{μ_{c}ϵ_{c}}−κ\sqrt{μ₀ϵ₀}) and the wavenumber (i.e., a second wavenumber) of the right-handed circularly polarized light is k₂=ω(\sqrt{μ_{c}ϵ_{c}}+↓\sqrt{μ₀ϵ₀}).

Therefore, the interior field model may be represented as:

$${E}^{int} = {\sum }_{n = 1}^{∞} {\sum }_{m = - n}^{n} [ \text{} {A}_{mn} {M}_{mn}^{( 1 )} ( r , {k}_{1} ) + {A}_{mn} {N}_{mn}^{( 1 )} ( r , {k}_{1} ) + {B}_{mn} {M}_{mn}^{( 1 )} ( r , {k}_{2} ) - {B}_{mn} {N}_{mn}^{( 1 )} ( r , k 2 ) ] ,$$

$$and$$

$${H}^{int} = \frac{k}{i ω μ} {\sum }_{n = 1}^{∞} {\sum }_{m = - n}^{n} [ \text{} {A}_{mn} {M}_{mn}^{( 1 )} ( r , {k}_{1} ) + {A}_{mn} {N}_{mn}^{( 1 )} ( r , {k}_{1} ) - {B}_{mn} {M}_{mn}^{( 1 )} ( r , {k}_{2} ) + {B}_{mn} {N}_{mn}^{( 1 )} ( r , k 2 ) ] ,$$

where E^{int} is the internal electric field of the chiral nanoparticle; and H^{int} is the internal magnetic field of the chiral nanoparticle.

Further, based on boundary conditions r×E^{int}=r×(E^{ip}+E^{s}) and r×H^{int}=r×(H^{ip}+H^{s}), after the foregoing expressions of the interior field model and the exterior field model (i.e., the incident field model and the scattering field model) are substituted, the first scattering coefficient

$${A}_{mn}^{s}$$

and the second scattering coefficient

$${B}_{m n}^{s}$$

may be calculated.

For example, the expressions of the first scattering coefficient

$${A}_{m n}^{s}$$

and the second scattering coefficient

$${B}_{mn}^{s}$$

are constructed:

$$\{ \begin{matrix}{A}_{m n}^{s} = {A}_{n}^{s a} {a}_{m n}^{i R} + {A}_{n}^{s b} {b}_{m n}^{i R} \\ {B}_{m n}^{s} = {B}_{n}^{s a} {a}_{m n}^{i R} + {B}_{n}^{s b} {b}_{m n}^{i R}\end{matrix} .$$

$${A}_{m n}^{i R}$$

is the first expansion coefficient of the right-handed circularly polarized light;

$${b}_{m n}^{i R}$$

is the second expansion coefficient of the right-handed circularly polarized light;

$${A}_{n}^{s a}$$

is the first intermediate variable;

$${A}_{n}^{s b}$$

is the second intermediate variable;

$${B}_{n}^{s a}$$

is the third intermediate variable; and

$${B}_{n}^{s b}$$

is the fourth intermediate variable, satisfying:

$${A}_{n}^{s a} = \frac{{Ψ}_{n} ( ka )}{{ξ}_{n} ( ka )} \frac{\frac{{D}_{n}^{( 1 )} ( {k}_{1} a ) - {η}_{r} {D}_{n}^{( 1 )} ( ka )}{{η}_{r} {D}_{n}^{( 1 )} ( {k}_{1} a ) - {D}_{n}^{( 3 )} ( ka )} + \frac{{D}_{n}^{( 1 )} ( {k}_{2} a ) - {η}_{r} {D}_{n}^{( 1 )} ( ka )}{{η}_{r} {D}_{n}^{( 1 )} ( {k}_{2} a ) - {D}_{n}^{( 3 )} ( ka )}}{\frac{{η}_{r} {D}_{n}^{( 3 )} ( ka ) - {D}_{n}^{( 1 )} ( {k}_{1} a )}{{η}_{r} {D}_{n}^{( 1 )} ( {k}_{1} a ) - {D}_{n}^{( 3 )} ( ka )} + \frac{{η}_{r} {D}_{n}^{( 3 )} ( ka ) - {D}_{n}^{( 1 )} ( {k}_{2} a )}{{η}_{r} {D}_{n}^{( 1 )} ( {k}_{2} a ) - {D}_{n}^{( 3 )} ( ka )}} ,$$

$${A}_{n}^{sb} = \frac{{Ψ}_{n} ( ka )}{{ξ}_{n} ( ka )} \frac{\frac{{η}_{r} {D}_{n}^{( 1 )} ( {k}_{1} a ) - {D}_{n}^{( 1 )} ( ka )}{{η}_{r} {D}_{n}^{( 1 )} ( {k}_{1} a ) - {D}_{n}^{( 3 )} ( ka )} - \frac{{η}_{r} {D}_{n}^{( 1 )} ( {k}_{2} a ) - {D}_{n}^{( 1 )} ( ka )}{{η}_{r} {D}_{n}^{( 1 )} ( {k}_{2} a ) - {D}_{n}^{( 3 )} ( ka )}}{\frac{{η}_{r} {D}_{n}^{( 3 )} ( ka ) - {D}_{n}^{( 1 )} ( {k}_{1} a )}{{η}_{r} {D}_{n}^{( 1 )} ( {k}_{1} a ) - {D}_{n}^{( 3 )} ( ka )} + \frac{{η}_{r} {D}_{n}^{( 3 )} ( ka ) - {D}_{n}^{( 1 )} ( {k}_{2} a )}{{η}_{r} {D}_{n}^{( 1 )} ( {k}_{2} a ) - {D}_{n}^{( 3 )} ( ka )}} ,$$

$${B}_{n}^{sa} = {A}_{n}^{sb} ,$$

$$and$$

$${B}_{n}^{s b} = \frac{{Ψ}_{n} ( ka )}{{ξ}_{n} ( ka )} \frac{\frac{{η}_{r} {D}_{n}^{( 1 )} ( {k}_{1} a ) - {D}_{n}^{( 1 )} ( ka )}{{D}_{n}^{( 1 )} ( {k}_{1} a ) - {η}_{r} {D}_{n}^{( 3 )} ( ka )} + \frac{{η}_{r} {D}_{n}^{( 1 )} ( {k}_{2} a ) - {D}_{n}^{( 1 )} ( ka )}{{D}_{n}^{( 1 )} ( {k}_{2} a ) - {η}_{r} {D}_{n}^{( 3 )} ( ka )}}{\frac{{D}_{n}^{( 3 )} ( ka ) - {η}_{r} {D}_{n}^{( 1 )} ( {k}_{1} a )}{{D}_{n}^{( 1 )} ( {k}_{1} a ) - {η}_{r} {D}_{n}^{( 3 )} ( ka )} + \frac{{D}_{n}^{( 3 )} ( ka ) - {η}_{r} {D}_{n}^{( 1 )} ( {k}_{2} a )}{{D}_{n}^{( 1 )} ( {k}_{2} a ) - {η}_{r} {D}_{n}^{( 3 )} ( ka )}} ,$$

where Ψₙ(⋅) is the Riccati-Bessel equation of the first kind; ξₙ(⋅) is the Riccati-Bessel equation of the third kind;

$${D}_{n}^{( 1 )} ( \cdot )$$

is the logarithmic derivative of the Riccati-Bessel equation of the first kind, and

$${D}_{n}^{( 1 )} ( \cdot ) = \frac{{Ψ}_{n}^{′} ( \cdot )}{{Ψ}_{n} ( \cdot )} ; {Ψ}_{n}^{′} ( \cdot )$$

is the derivative of Ψₙ(⋅); ηᵣ is the fifth intermediate variable;

$${η}_{r} = \frac{\sqrt{ϵ / μ}}{\sqrt{{ϵ}_{c} / {μ}_{c}}} ;$$

ϵ is the permittivity of the ambient medium; μ is the permeability of the ambient medium; ϵ_{c} is the permittivity of the chiral nanoparticle; μ_{c} is the permeability of the chiral nanoparticle;

$${D}_{n}^{( 3 )} ( \cdot )$$

is the logarithmic derivative of the Riccati-Bessel equation of the third kind, and

$${D}_{n}^{( 3 )} ( \cdot ) = \frac{{ξ}_{n}^{′} ( \cdot )}{{ξ}_{n} ( \cdot )} ; {ξ}_{n}^{′} ( \cdot )$$

is the derivative of ξₙ(⋅); a is the radius of the chiral nanoparticle; k is the wavenumber in the ambient medium; k=ω\sqrt{ϵμ}; ω is the angular frequency of the incident wave; k₁ is the wavenumber of the left-handed circularly polarized light; k₁=(\sqrt{μ_{c}ϵ_{c}}−κ\sqrt{μ₀ϵ₀}); k₂ is the wavenumber of the right-handed circularly polarized light; k₂=(\sqrt{μ_{c}ϵ_{c}}+κ\sqrt{μ₀ϵ₀}); x is the chirality parameter of the chiral nanoparticle; μ₀ is the permeability of vacuum; and ϵ₀ is the permittivity of vacuum.

The photonic spin Hall shift expression In the chiral sphere model Is derived from the Mie scattering theory. Because the spin Hall shift is a function of the scattering angle, this embodiment focuses solely on the peak of the spin Hall shift under this set of parameters during the adjustment of the chirality parameter. This approach enables clear observation of variations in peak magnitude. However, in addition to the chirality parameter, the dual-symmetric conditions are also a critical factor influencing the spin Hall shift. Therefore, the embodiments of the present invention further include coordinating the dual symmetry by adjusting the wavelength of the incident wave.

Specifically, the dual symmetry may be described by using a transfer function. In the embodiments of the present invention, an external adjustable parameter may be optimized by constructing and analyzing a transfer function, thereby achieving a maximum photonic spin Hall shift. In this process, the external adjustable parameter is an incident light wavelength. The effect of the photonic spin Hall shift may be significantly enhanced by selecting a suitable wavelength, making the effect clearer. This not only is conducive to enhancing the sensitivity of measurements, but also can effectively mitigate an error during comparison and analysis, thereby enhancing the accuracy and reliability of measurement results.

Further, the definition of the transfer function is

$$𝒯 = {w}_{- p}^{sca} / {w}_{p}^{sca} ,$$

that is, a ratio of the energy of the opposite-helicity component of the incident field to the energy of the same-helicity component in the scattering field. The expression of the scattering field model is substituted into the transfer function, represented as:

$$𝒯 = \frac{{w}_{- p}^{sca}}{{w}_{p}^{sca}} = \frac{{\sum }_{n = 1}^{∞} \frac{{{n}^{2} ( n + 1 )}^{2}}{2 n + 1} {\vert {A}_{1 n}^{s} - {B}_{1 n}^{s} \vert}^{2}}{{\sum }_{n = 1}^{∞} \frac{{{n}^{2} ( n + 1 )}^{2}}{2 n + 1} {\vert {A}_{1 n}^{s} + {B}_{1 n}^{s} \vert}^{2}} ,$$

where when the dual-symmetric conditions are satisfied, [symbol] is 0 (i.e., when infinitesimally approaching dual symmetry, the magnitude of the transfer function approaches 0 asymptotically).

The spin Hall effect of light originates from the momentum transfer between spin angular momentum and orbital angular momentum when a beam propagates through a medium with a refractive index gradient. Its ultimate manifestation is a transverse displacement in the perceived position of the interacting body, which can be represented as:

$${Δ}_{SH} = {lim}_{r \to ∞} - r ( \frac{{P}_{φ}}{\vert {P}_{r} \vert} ) \hat{φ} ,$$

where P_{φ} is the component of the Poynting vector of a scattering wave in the direction of the third component φ of a coordinate vector in the spherical coordinate system; Pᵣ is the component of the Poynting vector of the scattering wave in the direction of the first component r of the coordinate vector in the spherical coordinate system; and \hat{φ} is the unit vector of in the direction of the third component Y of the coordinate vector in the spherical coordinate system.

For example, the expression of the correspondence mapping between the photonic spin Hall shift Δ_{SH} and the chirality parameters is constructed:

$$\{ \begin{matrix}{Δ}_{SH} = \frac{1}{k} \frac{\sqrt{2} sin θ \cdot Re ( \begin{matrix}{S}_{1}^{*} \cdot ( {\sum }_{n = 1}^{∞} ( {( - i )}^{n + 1} n ( n + 1 ) {B}_{1 n}^{s} \frac{{P}_{n}^{1}}{sin θ} ) ) + \\ {S}_{2} \cdot {\sum }_{n = 1}^{∞} ( {( i )}^{n + 1} n ( n + 1 ) {( {A}_{1 n}^{s} \frac{{P}_{n}^{1}}{sin θ} )}^{*} )\end{matrix} )}{{\vert {S}_{2} \vert}^{2} + {\vert {S}_{1} \vert}^{2}} \\ {S}_{1} = \sqrt{2} {\sum }_{n = 1}^{∞} {\sum }_{m = - n}^{n} ( {( - i )}^{n + 1} ( {A}_{mn}^{s} \frac{{dP}_{n}^{m}}{d θ} + m \cdot {B}_{mn}^{s} \frac{{P}_{n}^{m}}{sin θ} ) ) \\ {S}_{2} = \sqrt{2} {\sum }_{n = 1}^{∞} {\sum }_{m = - n}^{n} ( {( - i )}^{n + 1} ( {B}_{mn}^{s} \frac{{dP}_{n}^{m}}{d θ} + m \cdot {A}_{mn}^{s} \frac{{P}_{n}^{m}}{sin θ} ) )\end{matrix} ,$$

θ is the second component of a coordinate vector in a spherical coordinate system, i.e., the scattering angle; Re(⋅) represents taking the real part of a complex number;

$${B}_{1 n}^{s}$$

is the second scattering coefficient when m is 1;

$${P}_{n}^{1}$$

is the associated Legendre polynomial when m is 1; S₁ is the first scattering matrix amplitude; S₂ is the second scattering matrix amplitude;

$${A}_{1 n}^{s}$$

is the first scattering coefficient when m is 1;

$${P}_{n}^{m}$$

is the associated Legendre polynomial; and (⋅)* represents complex conjugation of a complex number.

When light interacts with a medium, the conservation of angular momentum of light leads to coupling between the spin degree of freedom and the orbital motion of photons. This spin-orbit interaction is the origin of the spin Hall shift. The Dirac-form Maxwell equations can describe the local spin and orbital momentum as well as their spin-orbit interaction, expressed as:

$$c ( α \cdot p ) ϕ + \hat{β} V ϕ = i \partial / \partial t ϕ ,$$

where c is the speed of light in vacuum; both α and β are Dirac matrices; φ is the wave function of the electric field and the magnetic field, represented as φ=\sqrt{(4w)⁻¹}[\sqrt{ϵ₀}E,\sqrt{μ₀}H]^{T}, and T represents matrix transpose; p is the momentum operator −i∇; and V is the optica potential induced by the dielectric medium. The orbital momentum density p^{o} is defined by [symbol] φ|−i∇| [symbol] , which may characterize the trajectory of photons, with its explicit expression given as:

$${p}^{o} = {( 4 ω )}^{- 1} Im [ {ϵ}_{0} {E}^{*} ( ∇ ) E + {μ}_{0} {H}^{*} ( ∇ ) H ] ,$$

where Im(⋅) is taking the imaginary part of a complex number. In addition, the orbital momentum density can be used for characterizing the near-field spin-orbit coupling.

The values of corresponding photonic spin Hall shifts may be theoretically calculated through the parameters such as the permittivity, the permeability, and the particle radius. These values of shifts and the chirality parameters of particles have clear mapping relations. Based on this, a detailed mapping table may be constructed from the photonic spin Hall shifts corresponding to different chirality parameters. During an actual experiment, once a photonic spin Hall shift of a particle is measured, the chirality parameter of the particle may be rapidly and accurately inversely derived by looking up the mapping table. This method provides an efficient and reliable path for the rapid identification and characterization of chirality particles in an experiment.

Specifically, in step S3, when the chiral nanoparticle to be probed is illuminated with circularly polarized light and the Spin Hall Effect of Light is induced, the incident light wavelength is adjusted until the dual symmetry is satisfied to maximize the photonic spin Hall shift. The maximum photonic spin Hall shift is the optimal photonic spin Hall shift.

The Incident light wavelength Is adjusted to minimize the transfer function In step S2 to satisfy the dual-symmetric conditions. The photonic spin Hall shifts under different chirality parameters may be obtained by substituting the parameters and the scattering coefficient in this case into the expression of the spin Hall shift.

Further, after the incident light wavelength is adjusted until the dual symmetry is satisfied in step S3, the method further includes measuring the photonic spin Hall shift of the chiral nanoparticle to be probed. Because the photonic spin Hall shift is generally extremely weak, a quantum weak measurement technique usually needs to be used to observe the photonic spin Hall shift. A weak measurement usually includes three steps: preselection, weak coupling, and post-selection. The objective of the preselection is to adjust the polarization state of an incident beam to a specific initial state, so that a photonic spin Hall shift can be effectively observed in the subsequent weak coupling process. The weak coupling induces a slight transverse displacement in the beam through an air-glass interface or another inhomogeneous medium. The objective of the post-selection is to extract scattering field signatures associated with the photonic spin Hall shift through a second polarizer. Specific steps of acquiring the photonic spin Hall shift through the weak measurement are as follows.

First, an incident beam is passed through a first polarizer to reach a preselected state. A high-precision, high-transmittance polarizer is selected to ensure a pure and stable polarization state of the incident beam. The polarization direction of the incident beam is aligned with the experimental design by precisely adjusting the angle of the polarizer. For example, the polarization state can be precisely controlled using half-wave plates or quarter-wave plates. The intensity of the incident beam is enhanced by using a high-power laser source or optimizing the optical path design, thereby improving the signal-to-noise ratio of measurements.

Next, a weak coupling interaction is induced through a high-refractive-index-contrast material. Specifically, the high-refractive-index-contrast material (e.g., an air-glass interface) is used to enhance the photonic spin Hall shift. High-refractive-index contrast can enhance the spin-orbit coupling strength of photons. Optimal incidence conditions are identified by adjusting the angle of the incident beam to maximize the photonic spin Hall shift. Typically, incidence conditions near the critical angle can generate a larger shift. Introducing micro-nanostructures (e.g., gratings, nanopillars) at the interface can further enhance the photonic spin Hall shift. These structures can amplify the shift through localized field enhancement effects.

Finally, the post-selection is completed through the second polarizer to obtain the scattering field signatures. Specifically, it is ensured that the polarization axes of the two polarizers are precisely mutually perpendicular, thereby maximizing the interference effects. This can be achieved by using a high-precision optical adjustment platform. A high-sensitivity photodetector (e.g., a single-photon detector or a high-resolution camera) is selected to capture a weak scattering light signal. Through repeated measurements and averaging, noise can be effectively reduced, and the precision of measurements can be enhanced. Signatures of photonic spin Hall shifts are extracted from complex scattering fields by using sophisticated data analysis methods (e.g., Fourier transform, and wavelet analysis).

Through the foregoing method, the photonic spin Hall shift can achieve measurable precision.

Specifically, in step S4, a chirality parameter of the chiral nanoparticle to be probed under the maximum photonic spin Hall shift is determined based on the correspondence mapping between optimal photonic spin Hall shifts and chirality parameters.

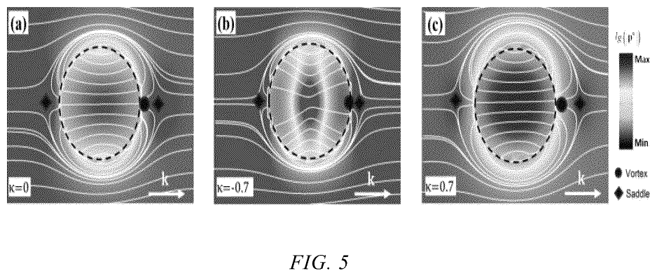

When the dual symmetry is satisfied, the magnitude of the transfer function T is 0. In the embodiments of the present invention, a silicon sphere with a relative permittivity of 3.552, a permeability of 1, and a radius of 131 nm is studied (ambient medium: vacuum). When the chirality parameter is 0 (i.e., no chirality), the dual-symmetric conditions are satisfied under illumination by circularly polarized light (here, right-handed circularly polarized light) with a wavelength of approximately 1068 nm. In this case, the peak of the photonic spin Hall shift reaches its maximum of about 1.9 times the wavelength, as shown in FIG. 4. The wavelength of the incident light is used as the unit for the values of the spin Hall shift in (a) in FIG. 4, i.e., Δ_{SH}/λ.

In the wavelength band from 1050 nm to 1100 nm in (a) in FIG. 4, as the chirality parameter changes, the magnitude of the transfer function corresponding to the maximum value of the spin Hall shift in the same wavelength band is obtained. When the value is smaller and closer to zero, the system is closer to dual symmetry.

(b) in FIG. 4 shows the magnitudes of the transfer function of the system under different wavelengths of incident light and chirality parameters. It may be obtained that as the chirality parameter changes, the wavelength at which the dual symmetry is satisfied also changes accordingly, and matches the parameter for the maximum peak of the spin Hall shift in (a) in FIG. 4. Through the observation of the maximum peaks of the spin Hall shift at each chirality under these dual-symmetric conditions, it can be seen that the impact of the chirality on the peak also significantly exhibits a particular linear change pattern. When the chirality parameter is closer to 1, the peak of the spin Hall shift thereof can reach 2.5 times the wavelength. For a nanoparticle with opposite handedness (i.e., the chirality parameter approaches −1), the peak can only reach approximately one time the wavelength. Therefore, nanoparticles with different chirality may be distinguished by comparing the magnitudes of the peaks of the spin Hall shifts.

In addition, the spin Hall shift is also related to near-field spin-orbit coupling. When stronger spin-orbit coupling occurs near a particle, a corresponding peak of a spin Hall shift is larger. Streamlines of orbital momentum density are a visual way of observing such near-field spin-orbit interactions. After chirality is added, the streamlines and the intensity distribution of the orbital momentum density are also affected accordingly, as shown in FIG. 5. When light enters a nanoparticle, spin angular momentum possessed by circularly polarized light is transferred to orbit angular momentum. Therefore, the magnitude of the orbital momentum density and the twisting degree of streamlines can visually reflect the strength of spin-orbit coupling to some extent. It is found that for a particle with a larger chirality parameter, as shown in I in FIG. 5, the orbital momentum density near the particle has larger distribution values within a larger range, and the twisting degree of streamlines is higher. In contrast, for a particle with opposite handedness, as shown in (b) in FIG. 5, the value of orbital momentum density is smaller, and the twisting degree of streamlines is slightly weaker. The orbital momentum density reflects near-field spin-orbit coupling, thereby further reflecting different near-field chiral information. (a), (b), and (c) in FIG. 5 are respectively streamlines of orbital momentum density near chiral nanoparticles and corresponding intensity distribution when the chirality parameters are 0, −0.7, and 0.7 (the wavelengths of incident light are respectively 1068 nm, 1081 nm, and 1081 nm, that is, wavelengths at which dual symmetry can be satisfied under different chirality parameters, as shown in (b) in FIG. 4). Circles and boxes in FIG. 5 mark the corresponding two types of singularities.

Photonic spin Hall shifts within a wavelength interval from 1050 nm to 1100 nm under different chirality parameters are shown in (a) in FIG. 4. It needs to be noted that the photonic spin Hall shift is related to an angle of observation. A variation curve of the spin Hall shift with respect to the scattering angle θ should be obtained in step S2. However, the truly valuable information is its peaks. Therefore, the magnitudes of the peaks of the spin Hall shifts under different parameters are shown in (a) in FIG. 4. During an actual measurement process, it is not necessary to draw curves of spin Hall shifts under every set of parameters to record corresponding maximum values in this embodiment. Results shown in FIG. 4 are obtained through the values of the transfer function calculated in step S2, and parameters that satisfy the dual symmetry may be found. It is only necessary to draw a curve of spin Hall shifts for these parameter sets. A chirality parameter of a chiral nanoparticle can be visually determined from the magnitudes of peaks of spin Hall shifts in this embodiment.

The method for probing a chirality parameter using a photonic spin Hall shift provided in the embodiments of the present invention utilizes the advantage that a spin Hall shift is highly sensitive to a permittivity, a permeability, and a particle radius of a chiral nanoparticle and has high sensitivity in the use for chirality probing. The photonic spin Hall shifts of the chiral nanoparticles with the chirality parameters are determined under the dual-symmetric conditions, to determine the correspondence mapping between the photonic spin Hall shifts and the chirality parameters, so that a chirality parameter of a chiral nanoparticle can be visually determined from the magnitudes of peaks of spin Hall shifts.

### Embodiment 2

Based on the same inventive idea, this embodiment provides a system for probing a chirality parameter based on a photonic spin Hall shift. The problem-solving principle of the system is similar to that of the method for probing a chirality parameter based on a photonic spin Hall shift provided in Embodiment 1. Details are not described again.

This embodiment provides a system for probing a chirality parameter based on a photonic spin Hall shift, including:
an acquisition module, configured to acquire a permittivity, a permeability, and a particle radius of a chiral nanoparticle to be probed;
a correspondence mapping acquisition module, configured to: determine photonic spin Hall shifts of chiral nanoparticles with different chirality parameters under dual-symmetric conditions based on the permittivity, the permeability, and the particle radius, and obtain a correspondence mapping between the photonic spin Hall shifts and the different chirality parameters;
an adjustment module, configured to: Illuminate the chiral nanoparticle to be probed with circularly polarized light to induce a Spin Hall Effect of Light, and when the Spin Hall Effect of Light is induced, adjust an incident light wavelength until dual symmetry is satisfied to obtain an optimal photonic spin Hall shift; and
a determination module, configured to determine a chirality parameter of the chiral nanoparticle to be probed based on the optimal photonic spin Hall shift and the correspondence mapping.

### Embodiment 3

This embodiment provides a chiral molecule detection apparatus, including the system for probing a chirality parameter based on a photonic spin Hall shift in Embodiment 2.

Persons skilled in this area should understand that the embodiments of the present application may be provided as a method, a system, or a computer program product. Therefore, the present application may use a form of a hardware-only embodiment, a software-only embodiment, or an embodiment with a combination of software and hardware. In addition, the present application may use a form of a computer program product implemented on one or more computer-usable storage media (including, but not limited to, a disk memory, a CD-ROM, an optical memory, and the like) that include computer-usable program code.

The present application Is described with reference to the flowcharts and/or block diagrams of the method, the device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

Obviously, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived there from still fall within the scope of protection of the present invention.

What is claimed is:

1. A method for probing a chirality parameter based on photonic spin Hall shift, comprising steps of:
S1, acquiring a permittivity, a permeability, and a particle radius of a chiral nanoparticle to be probed;
S2, determining photonic spin Hall shifts of chiral nanoparticles with different chirality parameters under dual-symmetric conditions based on the permittivity, the permeability, and the particle radius, and obtaining a correspondence mapping between the photonic spin Hall shifts and the different chirality parameters;
S3, illuminating the chiral nanoparticle to be probed with circularly polarized light to induce a Spin Hall Effect of Light, and when the Spin Hall Effect of Light is induced, adjusting an incident light wavelength until dual symmetry is satisfied to obtain an optimal photonic spin Hall shift; and
S4, determining a chirality parameter of the chiral nanoparticle to be probed based on the optimal photonic spin Hall shift and the correspondence mapping.

2. The method for probing a chirality parameter based on a photonic spin Hall shift according to claim 1, wherein the step of determining photonic spin Hall shifts of chiral nanoparticles with different chirality parameters under dual-symmetric conditions based on the permittivity, the permeability, and the particle radius in S2 comprises:
obtaining a constitutive relation of the chiral nanoparticle to be probed based on the permittivity, the permeability, and the particle radius;
constructing an incident field model and a scattering field model, and obtaining an photonic spin Hall shift expression based on the incident field model, the scattering field model, and the constitutive relation; and
determining the photonic spin Hall shifts of the chiral nanoparticles with the different chirality parameters based on the photonic spin Hall shift expression under the dual-symmetric conditions.

3. The method for probing a chirality parameter based on a photonic spin Hall shift according to claim 1, wherein the step of obtaining a correspondence mapping between the photonic spin Hall shifts and the different chirality parameters in S2 is:
constructing an interior field model of the chiral nanoparticle for obtaining a first scattering coefficient and a second scattering coefficient;
calculating a first scattering matrix amplitude and a second scattering matrix amplitude based on the first scattering coefficient and the second scattering coefficient; and
obtaining the correspondence mapping between the photonic spin Hall shifts and the different chirality parameters based on the first scattering matrix amplitude and the second scattering matrix amplitude.

4. The method for probing a chirality parameter based on a photonic spin Hall shift according to claim 3, wherein the constructing an interior field model of the chiral nanoparticle for obtaining a first scattering coefficient and a second scattering coefficient comprises:
decomposing any optical field entering a chiral medium into a left-handed circularly polarized field component and a right-handed circularly polarized field component;
constructing a first expansion coefficient and a first wavenumber of the left-handed circularly polarized field component, constructing a second expansion coefficient and a second wavenumber of the right-handed circularly polarized field component, and constructing the interior field model of the chiral nanoparticle based on the first expansion coefficient, the first wavenumber, the second expansion coefficient, and the second wavenumber; and
acquiring the incident field model and the scattering field model, and calculating the first scattering coefficient and the second scattering coefficient based on the incident field model, the scattering field model, and the interior field model.

5. The method for probing a chirality parameter based on a photonic spin Hall shift according to claim 1, wherein the photonic spin Hall shift expression is:
$${Δ}_{SH} = \frac{1}{k} \frac{\sqrt{2} sin θ \cdot Re ( \begin{matrix}{S}_{1}^{*} \cdot ( {\sum }_{n = 1}^{∞} ( {( - i )}^{n + 1} n ( n + 1 ) {B}_{1 n}^{s} \frac{{P}_{n}^{1}}{sin θ} ) ) + \\ {S}_{2} \cdot {\sum }_{n = 1}^{∞} ( {( i )}^{n + 1} n ( n + 1 ) {( {A}_{1 n}^{s} \frac{{P}_{n}^{1}}{sin θ} )}^{*} )\end{matrix} )}{{\vert {S}_{2} \vert}^{2} + {\vert {S}_{1} \vert}^{2}} ,$$
wherein Δ_{SH} is the photonic spin Hall shift, k is a wavenumber in an ambient medium, θ is a second component of a coordinate vector in a spherical coordinate system, Re(⋅) represents taking a real part of a complex number, n is a first summation index, i is an imaginary unit,
$${A}_{1 n}^{s}$$
is a first scattering coefficient when a second summation index is 1,
$${B}_{1 n}^{s}$$
is a second scattering coefficient when the second summation index is 1,
$${P}_{n}^{1}$$
is an associated Legendre polynomial when the second summation index is 1, S₁ is a first scattering matrix amplitude, S₂ is the second scattering matrix amplitude, and (⋅)* represents complex conjugation of a complex number.

6. The method for probing a chirality parameter based on a photonic spin Hall shift according to claim 1, wherein the determining photonic spin Hall shifts of chiral nanoparticles with different chirality parameters under dual-symmetric conditions based on the permittivity, the permeability, and the particle radius in S2 further comprises constructing a transfer function, and minimizing the transfer function by adjusting an incident light wavelength to obtain the dual-symmetric conditions.

7. The method for probing a chirality parameter based on a photonic spin Hall shift according to claim 6, wherein an expression of the transfer function is:
$$𝒯 = \frac{{\sum }_{n = 1}^{∞} \frac{{{n}^{2} ( n + 1 )}^{2}}{2 n + 1} {\vert {A}_{1 n}^{s} - {B}_{1 n}^{s} \vert}^{2}}{{\sum }_{n = 1}^{∞} \frac{{{n}^{2} ( n + 1 )}^{2}}{2 n + 1} {\vert {A}_{1 n}^{s} + {B}_{1 n}^{s} \vert}^{2}} ,$$
wherein τ is the transfer function, n is the first summation index,
$${A}_{1 n}^{s}$$
is the first scattering coefficient when a second summation index is 1, and
$${B}_{1 n}^{s}$$
is the second scattering coefficient when the second summation index is 1.

8. The method for probing a chirality parameter based on a photonic spin Hall shift according to claim 1, wherein after the adjusting an incident light wavelength until dual symmetry is satisfied in S3, the method further comprises measuring a photonic spin Hall shift of the chiral nanoparticle to be probed, and the measuring the photonic spin Hall shift comprises:
passing a beam through a first polarizer to reach a preselected state;
transmitting the beam through a high-refractive-index-contrast material based on the preselected state to induce a weak coupling interaction to generate a transverse displacement; and
extracting scattering field signatures associated with the transverse displacement by a second polarizer, wherein polarization axes of the first polarizer and the second polarizer are mutually perpendicular.

9. A system for probing a chirality parameter based on a photonic spin Hall shift, comprising:
an acquisition module, configured to acquire a permittivity, a permeability, and a particle radius of a chiral nanoparticle to be probed;
a correspondence mapping acquisition module, configured to: determine photonic spin Hall shifts of chiral nanoparticles with different chirality parameters under dual-symmetric conditions based on the permittivity, the permeability, and the particle radius, and obtain a correspondence mapping between the photonic spin Hall shifts and the different chirality parameters;
an adjustment module, configured to: illuminate the chiral nanoparticle to be probed with circularly polarized light to induce Spin Hall Effect of Light, and when the Spin Hall Effect of Light is induced, adjust an incident light wavelength until dual symmetry is satisfied to obtain an optimal photonic spin Hall shift; and
a determination module, configured to determine a chirality parameter of the chiral nanoparticle to be probed based on the optimal photonic spin Hall shift and the correspondence mapping.
